(19) United States
(12) Patent Application Publication
(10) Pub. No.: US 2025/0280255 A1
(43) Pub. Date: Sep. 4, 2025

(54) ACOUSTIC SIMULATION BASED ON ACOUSTIC SCATTERING

(71) Applicant: Apple Inc., Cupertino, CA (US)

(72) Inventors: Dirk Schroeder, San Jose, CA (US); David E Romblom, Boulder, CO (US); Khaled Mammou, Danville, CA (US); David Flynn, Darmstadt (DE)

(21) Appl. No.: 19/055,979

(22) Filed: Feb. 18, 2025

Related U.S. Application Data
(60) Provisional application No. 63/559,975, filed on Mar. 1, 2024.

(51) Int. Cl. H04S 7/00; G06F 3/01; G06F 3/16

(52) U.S. Cl. CPC H04S 7/302; G06F 3/162; G06F 3/013; H04S 2400/11

(57) ABSTRACT

Various implementations disclosed herein include devices, systems, and methods that provide acoustic simulation in XR spaces using a 3D geometry of the space and scattering coefficients associated with surfaces. For example, a process may obtain data representing one or more objects in a physical environment corresponding to an extended reality (XR) environment. The process may further generate an original three-dimensional (3D) model representing the physical environment based on the sensor data. The process may further determine semantic information corresponding to the one or more objects and obtain scattering coefficients for the one or more objects based on the semantic information corresponding to the one or more objects.

### CROSS-REFERENCE TO RELATED APPLICATIONS

This Application claims the benefit of U.S. Provisional Application Ser. No. 63/559,975 filed Mar. 1, 2024, which is incorporated herein in its entirety.

### TECHNICAL FIELD

The present disclosure generally relates to systems, methods, and devices that provide an acoustic simulation within extended reality (XR) spaces using a 3-dimensional (3D) geometry of the XR spaces in combination with scattering coefficients associated with a periodical and geometrical structure of a surface of an object(s) within the XR spaces.

### BACKGROUND

Existing audio simulation techniques may be improved with respect to reducing a required memory size for real time processing and improving simulation accuracy, a memory footprint, and complexity.

### SUMMARY

Various implementations disclosed herein include devices, systems, and methods that are configured to provide an acoustic simulation within a XR space. In some implementations, sensor data (e.g., image and depth data) and/or modeled object data (e.g., modeled using a 3D graphics application to create a high complexity mesh for visualization) representing an object(s) within the XR space may be obtained to generate a 3D geometry of the XR space. In some implementations, an acoustic simulation within a XR space (or with respect to single objects within an XR space) may be provided by using the 3D geometry of the XR space (or an object within an XR space) in combination with scattering coefficients associated with geometrical properties of a surface(s) of the object(s) within the XR space. Object recognition processes and additional semantic information may be used to search for and retrieve mean scattering coefficients of similar objects (with respect to the objects within the XR space) from a database. In some implementations, mean scattering coefficients may be obtained by interpolating values with respect to dimensions of, for example, an object(s) or space. Likewise, scattering coefficients may be obtained using simplified compute models. Semantic information may include, inter alia, an object type (e.g., a TV, a sofa, a wall, etc.), raw dimensions (e.g., obtained through a single bounding box or multiple bounding boxes), a scene type (e.g., living room, bathroom, etc.), different types of furniture, materials, etc. Scattering coefficients from the database may be computed from large scale simulations of (annotated) geometrical acoustical ground truth (GT) data (e.g., Ground truth meshes including annotations, ground truth impulse response measurements, etc.), GT measurements, and/or using a simplified mesh with coefficients determined based on displacement information.

In some implementations, scattering coefficients may define wavelength-dependent reflection characteristics of a surface of the objects. The acoustic simulation technique may be applicable to room sensing systems and authoring systems.

In some implementations, scattering coefficients may be computed based on mesh simplification and displacement information. In some implementations, scattering coefficients may be computed based on a distributed system for computing and updating scattering coefficients. In some implementations, displacement information may be a displacement map associated with, inter alia, depth variability of portions surfaces of objects. In some implementations, a rasterization process may use computed displacements to generate a displacement map.

In some implementations, an acoustic simulation within a XR space may be provided using a 3D geometry of the XR space in combination with scattering coefficients associated with geometrical properties of surfaces of objects using mesh simplification and displacement mapping processes to determine scattering coefficients.

In some implementations, an electronic device has a processor (e.g., one or more processors) that executes instructions stored in a non-transitory computer-readable medium to perform a method. The method performs one or more steps or processes. In some implementations, the electronic device obtains data such as, e.g., sensor data and/or modeled object data representing one or more objects in a physical environment corresponding to an XR environment. In some implementations, an original 3D model representing the physical environment is generated based on the sensor data. In some implementations, semantic information corresponding to the one or more objects may be determined and scattering coefficients for the one or more objects may be obtained based on the semantic information corresponding to the one or more objects providing simulated acoustics within the XR environment based on the original 3D model and the scattering coefficients for the one or more objects. Subsequently, simulated acoustics may be provided within the XR environment based on the original 3D model and the scattering coefficients for the one or more objects.

In some implementations, an electronic device has a processor (e.g., one or more processors) that executes instructions stored in a non-transitory computer-readable medium to perform a method. The method performs one or more steps or processes. In some implementations, the electronic device obtains data such as, e.g., sensor data and/or modeled object data representing one or more objects in a physical environment corresponding to an XR environment. In some implementations, an original 3D model representing the physical environment may be generated based on the data. In some implementations, displacement information for portions of the original 3D model may be generated based on the data. Object-specific scattering coefficients may be determined for the one or more objects based on the displacement information and simulated acoustics may be provided within the XR environment based on the scattering coefficients for the one or more objects.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment corresponding to an extended reality (XR) environment, in accordance with some implementations.

FIG. 2 illustrates an S-curve estimation representing acoustic scattering coefficients associated with a periodical and geometrical structure of a surface of an object(s), in accordance with some implementations.

FIG. 3 illustrates an XR space associated with providing an acoustic simulation using a semantic-based scattering estimation process, in accordance with some implementations.

FIG. 4 illustrates a processing sequence associated with a machine learning (ML) based scattering estimation using multi-resolution meshes, in accordance with some implementations.

FIG. 5 illustrates a process executing a mapping function associated with computing a scattering estimation or surface scattering map, in accordance with some implementations.

FIG. 6 is a flowchart representation of an exemplary method that provides an acoustic simulation with respect to an object(s) in an XR space and/or any portion of an XR space using a 3D geometry of the object(s) and/or XR space and scattering coefficients associated with surfaces of the object(s) and/or the XR space, in accordance with some implementations.

FIG. 7 is a flowchart representation of an exemplary method that provides acoustic simulation with respect to an object(s) in an XR space and/or any portion of an XR space using a 3D geometry of the object(s) and/or XR space and scattering coefficients associated with surfaces of the object(s) and/or the XR space using mesh simplification and displacement mapping to determine scattering coefficients, in accordance with some implementations.

FIG. 8 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device.

Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

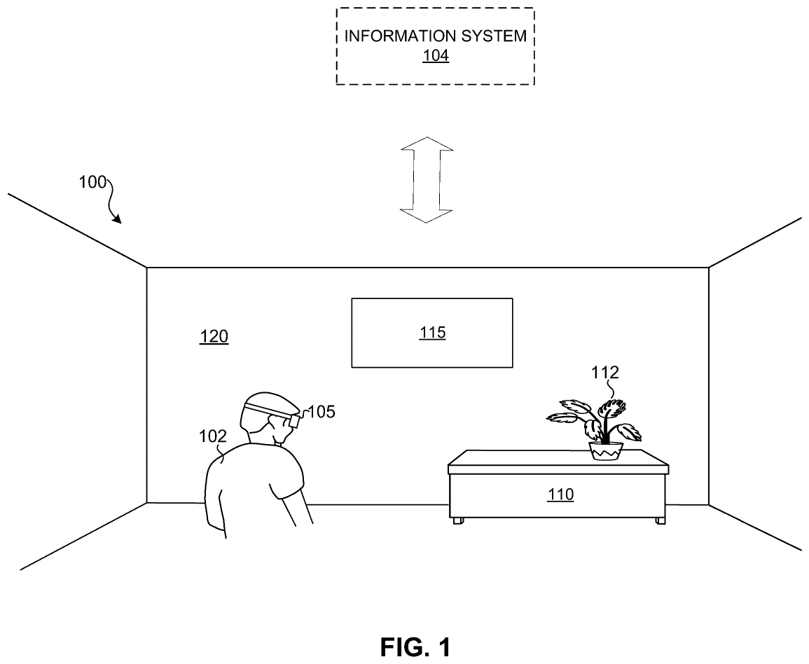

FIG. 1 illustrates an exemplary electronic device 105 operating in a physical environment 100 corresponding to an extended reality (XR) environment. Additionally, electronic device 105 may be in communication with an information system 104 (e.g., a device control framework or network). In an exemplary implementation, electronic device 105 is sharing information with the information system 104. In the example of FIG. 1, the physical environment 102 is a room that includes walls 120 and physical objects such as a desk 110, a television/monitor 115, and plant a 112. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an electronic device such as an HMD (e.g., device 105), communicatively coupled a server, or other external device may be configured to obtain data, such as sensor data (e.g., image and depth data) and/or modeled object data (e.g., modeled using a 3D graphics application to create a high complexity mesh for visualization) representing walls 120 and objects (e.g., desk 110, television/monitor 115, plant 112, etc.) in physical environment 100. The data is used to generate a three-dimensional (3D) model (e.g., a mesh) representing physical environment 100. Subsequently, semantic information corresponding to the objects is determined. The semantic information may include information associated with an object(s) (e.g., a TV, a sofa, a wall, etc.), raw dimensions (e.g., obtained through a single bounding box or multiple bounding boxes), a scene type (e.g., living room, bathroom, etc.), different types of furniture, materials, etc. In some implementations, scattering coefficients for the objects may be obtained based on the semantic information. In some implementations, scattering coefficients may be obtained by interpolating values with respect to dimensions of, for example, an object(s) or space. Likewise, scattering coefficients may be obtained using simplified compute models. In some implementations, scattering coefficients may be obtained by looking up mean scattering coefficients of similar objects (with respect to the objects) from a database. The scattering coefficients from the database may be determined from large scale simulations of (annotated) geometrical acoustical (GT) data (e.g., ground truth meshes including annotations, ground truth impulse response measurements, etc.), GT measurements, etc. Alternatively, the scattering coefficients from the database may be determined by using a simplified mesh with coefficients determined based on displacement information such as a displacement map associated with a simplified 3D model. The simplified 3D model and the scattering coefficients for the objects may be used to providing simulated acoustics within the XR environment.

In some implementations, an electronic device such as an HMD (e.g., device 105), communicatively coupled a server, or other external device may be configured to obtain sensor data (e.g., image and depth data) and/or modeled object data (e.g., modeled using a 3D graphics application to create a high complexity mesh for visualization) representing walls 120 and objects in (e.g., desk 110, television/monitor 115, plant 112, etc.) physical environment 100. The sensor data is used to generate an original 3D model (e.g., a mesh) representing physical environment 100. In some implementations, a simplified 3D model is generated based on the original 3D model and portions of the simplified 3D model corresponding to portions of the original 3D model are determined. Subsequently, displacement information (e.g., a displacement map) is generated for the portions of the simplified 3D model based on displacements (e.g., depth variability) for the portions (e.g., surfaces) of the original 3D model. For example, a rasterization process may use computed displacements to generate a displacement map, wavelet-coefficients, etc.). In some implementations, object-specific scattering coefficients may be determined for the objects based on the displacement information and simulated acoustics within the XR environment may be provided based on the scattering coefficients for the objects.

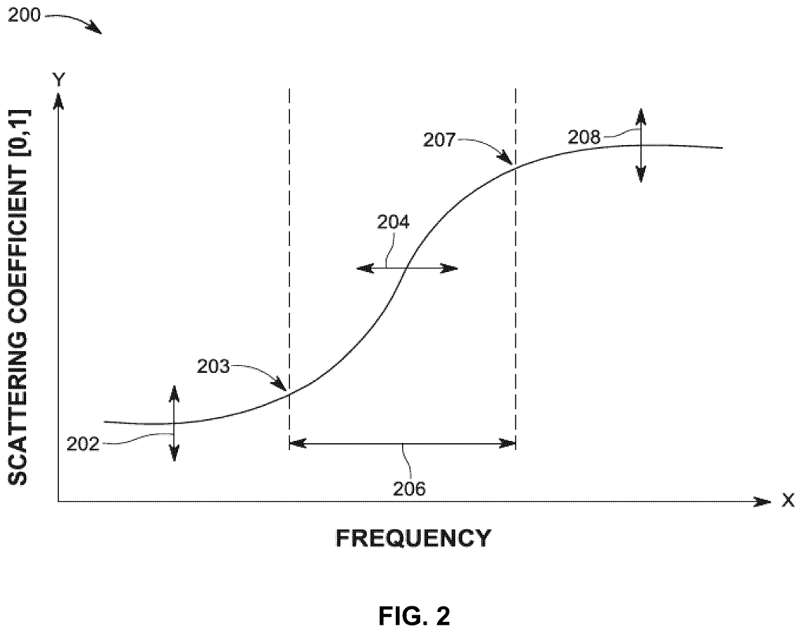

FIG. 2 illustrates an S-curve estimation 200 representing acoustic scattering coefficients associated with a periodical and geometrical structure of a surface of an object(s) such as a desk 110, a television/monitor 115, a plant 112, walls 120, etc. as illustrated with respect to FIG. 1, in accordance with some implementations. Acoustic scattering coefficients may be frequency dependent and may comprise a geometric measure of scattering parameters characterizing an amount of sound energy being reflected in a non-specular (diffuse) manner when interacting with surfaces of objects. A frequency-dependent behavior of the scattering coefficients is related to a size of irregularities on a surface of the objects. Therefore, a transition in scattering behavior, from low scattering coefficients to high scattering coefficients at specific frequencies, may be influenced by size of irregularities on a surface of the objects.

S-curve estimation 200 is a graphical representation describing a frequency-dependent behavior of scattering coefficients for a given surface of an object thereby illustrating how scattering characteristics of a surface of the object changes with respect to different frequencies. Therefore, S-curve estimation 200 represents parameters quantifying a scattering of sound waves interacting with objects. The parameters may include: start S parameters 202, end S parameters 208, convergence low frequency (LF) parameters 203, convergence high frequency (HF) parameters 207, a center point parameter 204, and scattering slope parameters 206.

Start S parameters 202 define a beginning point of S-curve estimation 200 and end S parameters 208 define an end point of S-curve estimation 200 thereby representing a range over which scattering coefficients are fluctuating. For example, S-curve estimation 200 begins at a low scattering coefficient (Start S parameters 202) indicating minimal scattering at low frequencies. As the scattering coefficient gradually increases it reaches a peak where scattering becomes more significant and then decreases to an endpoint (end S parameters 208) representing a saturation of scattering at high frequencies.

Convergence LF parameters 203 and convergence HF parameters 207 represent frequencies at which LF and HF components of the scattering coefficients converge thereby representing transitions in scattering behavior.

Center-point parameter 204 represents a reference frequency associated with a center location of S-curve estimation 200. Center-point parameter 204 influences a symmetry and shape of S-curve estimation 200.

Scattering slope parameters 206 describe how rapidly or how gradually scattering coefficients fluctuate between start S parameters 202 and end S parameters within S-curve estimation 200. For example, a steeper slope may suggest a rapid transition in scattering behavior. Slope parameters 206 may enable capture of essential features of S-curve estimation 200 and may provide a compact representation of the scattering behavior of a surface of an object thereby simplifying complex frequency-dependent scattering characteristics into a set of parameters that may be easily analyzed and compared across different object surfaces.

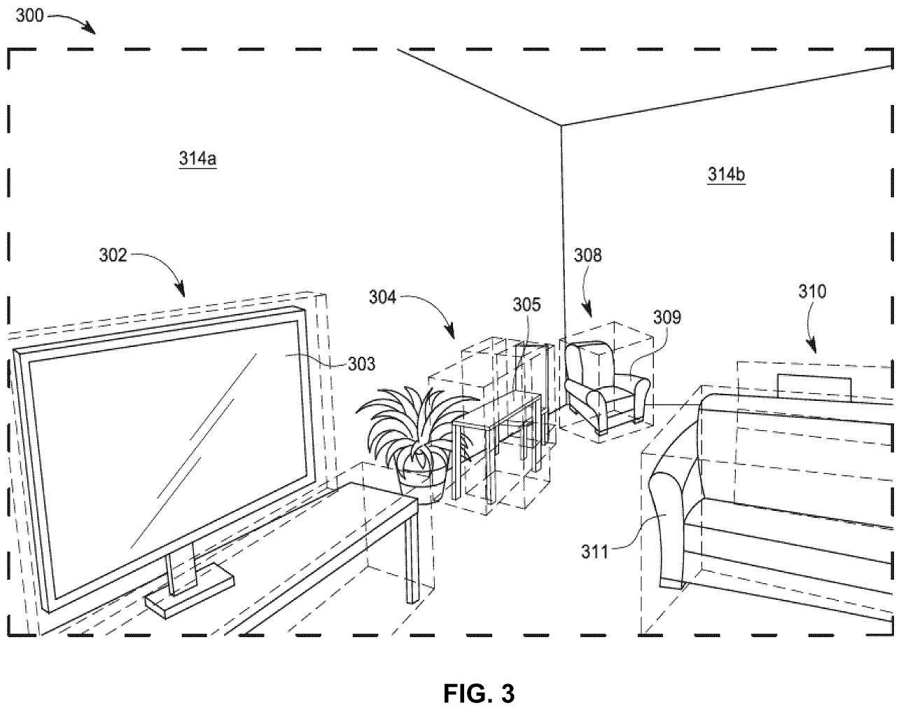

FIG. 3 illustrates an XR space 300 associated with providing an acoustic simulation using a semantic-based scattering estimation process, in accordance with some implementations. XR space 300 comprises walls 314a and 314b, an object 303 (e.g., a television), an object 304 (e.g., a table), an object 309 (e.g., a chair), and an object 311 (e.g., a sofa), etc. Some implementations provide a first estimation of surface parameters of an acoustic mesh associated with XR space 300 using real-time systems with room sensing capabilities. Some implementations provide a first estimation of surface parameters of an acoustic mesh associated with XR space 300 using rapid prototyping of virtual environments via authoring software providing room acoustics rendering in real-time.

In some implementations, light-weight methods for providing a first estimation of room acoustics (of XR space 300) are used in real-time systems with room sensing capabilities. For example, an initial estimation of acoustic surface parameters (e.g., absorption parameters, scattering parameters, etc.) may be determined for a generated 3D acoustic mesh such that the initial estimation represents real-world properties to achieve a plausible auralization (i.e., audibly rendering a sound field of a source within a space via a modeling process) of XR space 300.

In some implementations, rapid prototyping of virtual environments may be used to provide a first estimation of surface parameters of an acoustic mesh associated with XR space 300. For example, authoring software supporting real-time room acoustics rendering may be used during rapid prototyping of virtual environments to rapidly estimate surface parameters (e.g., absorption parameters, scattering parameters, etc.) for an acoustic mesh to facilitate the creation and testing of virtual environments (e.g., XR space 300) in real-time.

Subsequent to providing a first estimation of surface parameters of an acoustic mesh associated with XR space 300, an object recognition process is (in combination with additional semantics) may be utilized to search for mean scattering coefficients of similar objects (e.g., with respect to walls 214a and 314b and objects 303, 305, 309, and 311) from a database of scattering coefficients. In some implementations, mean scattering coefficients may be obtained by interpolating values with respect to dimensions of, for example, an object(s) or space (e.g., walls 214a and 314b, objects 303, 305, 309, 311, etc.). Likewise, scattering coefficients may be obtained using simplified compute models. The object recognition process is configured to identify and recognize objects in a scene (of XR space 300) based on input parameters, using object recognition techniques, and/or considering semantic information.

A query for searching for mean scattering coefficients from the database may include utilizing input parameters (associated with XR space 300) such as, inter alia, an object type (e.g., a TV, a sofa, a wall, etc.), raw input dimensions (e.g., obtained through a single or multiple bounding boxes such as bounding boxes 302, 304, 308, and 310), a scene type (e.g., a living room, a bathroom, different types of furniture, etc.), materials (e.g., metal, wood, etc.), etc. Input parameters associated with an object type may be determined by utilizing an object recognition model to identify an object type based on an input image or scene. Input parameters associated with raw input dimensions may be determined by extracting raw dimensions of a recognized object using bounding box information associated with any of bounding boxes 302, 304, 308, and 310. Extracting raw dimensions may include processing coordinates of bounding boxes 302, 304, 308, and 310 to obtain a width, a height, and a depth of objects 303, 305, 309, and 311. Input parameters associated with a scene type may be determined by utilizing a scene recognition model to identify the scene type.

The mean scattering coefficients (from the database) may be computed from large-scale numerical simulations of annotated ground truth (GT) data (e.g., ground truth meshes including annotations, ground truth impulse response measurements, etc.) and associated measurements in combination with implementing a method involving a detailed and simplified mesh of scanned objects such as objects 303, 305, 309, and 311.

The aforementioned processes may be implemented via room sensing systems and/or authoring systems.

In some implementations, an authoring system enables object classification of a virtual object via a manual label according in accordance with a taxonomy. For example, a manual labeling process in accordance with a taxonomy may include assigning labels or tags to virtual objects based on a predefined taxonomy or classification system. A taxonomy may provide a structured framework for categorizing objects and manually assigning associated labels to each object.

In some implementations, a machine learning (ML) based object recognition system may be implemented (via ML algorithms) to automatically classify virtual objects based on patterns and features present in associated data. For example, an ML model may be trained on a labeled dataset such that examples of objects and corresponding labels are used to train ML model to recognize patterns. Subsequent to training, the ML the model may classify new objects without explicit human labeling thereby making the ML model efficient for large datasets.

Subsequent to the aforementioned virtual object classification processes, scattering coefficients may be applied to a mesh representing an object.

In some implementations, an authoring system may apply scattering coefficients to a mesh representing an authored object resulting in assignment of specific scattering properties to the authored object to simulate an interaction with scatter waves.

In some implementations, a room sensing system may identify objects clustered in bounding volumes determined via bounding boxes 302, 304, 308, and 310. For example, scattering coefficients may be applied to all triangles within a bounding volume of a room such as XR space 300. A bounding volume may comprise a 3D space encapsulating a geometry of a room. Alternatively, a bounding volume may comprise multiple bounding boxes that are configured to divide an object into multiple portions. Likewise, scattering coefficients may be assigned to each triangle thereby influencing how they interact with scatter waves within the room. If the bounding volume of the room and/or objects is unknown, scattering coefficients may be applied based on object types present in the room as different object types may have predefined scattering properties.

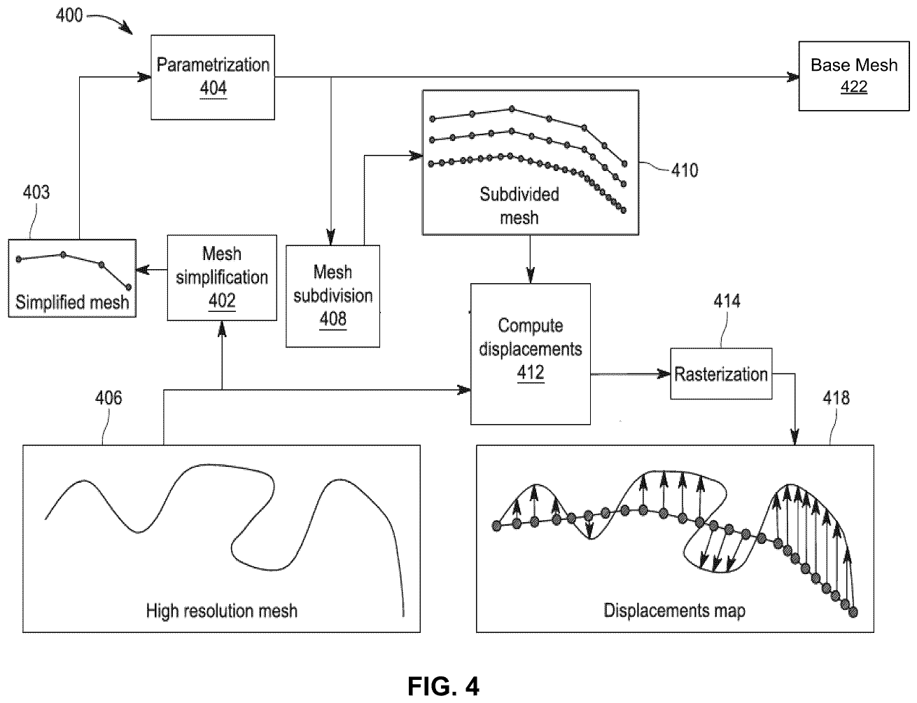

FIG. 4 illustrates a processing sequence 400 associated with a machine learning (ML) based scattering estimation process using multi-resolution meshes, in accordance with some implementations. Processing sequence 400 implements a process associated with manipulating a high-resolution mesh 406 via mesh simplification, parametrizing and subdividing the mesh, and computing displacements to generate a final output comprising a 2D map (e.g., displacements map 418) representing displacements of mesh vertices.

Processing sequence 400 is executed as follows:

At block 402, a mesh simplification process is executed with respect to high-resolution mesh 406. For example, a mesh triangle count of high-resolution mesh 406 may be reduced while preserving its shape with respect to a required wavelength (e.g., small and thin features are removed from high resolution mesh 406) resulting in a simplified mesh 403.

At block 404, a mesh parametrization process is executed to split the simplified mesh 403 into patches that are mapped to regions of a 2D plane while avoiding distortions in angles and distances between a 3D space (e.g., original high resolution mesh 406) and a 2D space (a parameterized representation of the original high resolution mesh 406). A resulting base mesh 422 is generated and may be used as a starting point for further processing.

At block 408, a mesh subdivision process is executed. A mesh subdivision process may include upsampling base mesh 422 by introducing new vertices in accordance with a predefined subdivision scheme. Positions of the newly introduced vertices may be determined based on vertices of the base mesh 422 and a redefined subdivision process. Base mesh vertices may be updated to better fit a shape of high resolution mesh 406. The mesh subdivision process results in a subdivided mesh 410. In some implementations, the mesh subdivision may include subdivision schemes such as, inter alia, a midpoint subdivision scheme, a loop subdivision scheme, a butterfly subdivision scheme, etc. A midpoint subdivision scheme may include introducing new vertices at a midpoint of each edge in base mesh 422. A loop subdivision scheme may include introducing new vertices at a midpoint of each edge (of base mesh 422) and at a weighted average of neighboring vertices thereby producing smoother surfaces. A butterfly subdivision scheme may include introducing new vertices based on a local neighborhood of vertices thereby creating a smooth surface by considering adjacent vertices.

At block 412, a process to compute displacements is executed. The process may include computing 3D vectors representing a displacement of subdivided mesh vertices to enable a better fit with respect to high resolution mesh 406. Displacements may be determined based on differences between positions of the subdivided vertices and corresponding positions in high resolution mesh 406. Computing the 3D vectors enables an illustration representing how each vertex in subdivided mesh 410 should be adjusted or be shifted to align with details of high resolution mesh 406.

At block 414, a rasterization process is executed. The rasterization process may include exploiting a parametrization of base mesh 422 to compute an image describing displacement fields as a 2D image. For example, rasterization comprises a process for converting vector-based data (such as a 3D mesh and its displacement information) into a raster image such as displacements map 418.

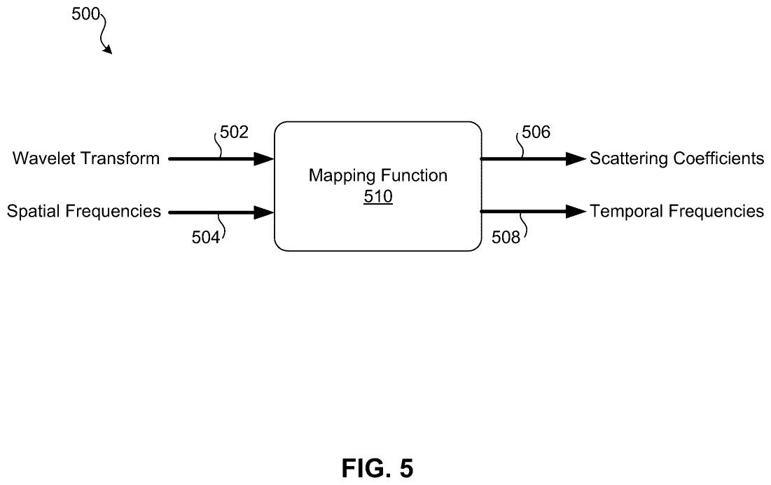

FIG. 5 illustrates a process 500 executing a mapping function 510 associated with computing a scattering estimation or a surface scattering map, in accordance with some implementations. Process 500 is configured to compute a surface scattering map by estimating a surface roughness at different scales using a 2D wavelet transform 502 applied to mapping function 510 (associated with a displacement map). Likewise, process 500 enables placement of padding between patches (of a split mesh), applying adaptive wavelet transforms, and subsequently estimating s-curve descriptors based on a wavelet-transformed roughness map. Padding may prevent contamination between neighboring patches during a wavelet transform thereby ensuring that an analysis of each patch is not influenced by adjacent patches.

Mapping function 510 is configured to map spatial frequencies 504 and temporal frequencies 508 thereby acknowledging an interconnected nature.

Process 500 may further include utilizing machine learning techniques (e.g., a neural network) to map wavelet coefficients (associated with wavelet transform 502) to s-curve descriptors and scattering coefficients 506. Mapping wavelet coefficients to s-curve descriptors may include transforming wavelet coefficients into a multi-resolution representation using S-curves thereby capturing and enhancing features in an associated signal. For example, an input signal may be transformed using wavelet transform 502 and wavelet coefficients may be obtained at different scales and positions thereby providing a multi-resolution representation of the input signal. Subsequently, s-curve descriptors may be generated from the wavelet coefficients and each wavelet coefficient may be mapped to an S-curve descriptor using mapping function 510. The S-curve descriptors may be configured to capture important characteristics of the wavelet coefficients. In some implementations, a scattering transform may be applied to the wavelet coefficients or S-curve descriptors by cascading wavelet transforms with modulus operations and averaging. A scattering layer may be configured to compute a series of scattering coefficients at different scales and orders thereby capturing invariant and discriminative features of the input signal. A resulting output of the scattering layer or the S-curve descriptors may be fed into a neural network to learn patterns and relationships of the input signal.

A machine learning technique such as a neural network may be trained using with ground truth (GT) data from large-scale numerical simulations or measurements, including objects with different levels of detail (LoD). GT data may be used as a reference for training a model thereby allowing it to learn a relationship between an input (wavelet coefficients, scattering coefficients) and a desired output (s-curve descriptors).

Mapping function 510 may be executed with respect to GT data by using a 2D composite plane and deforming the plane as a surface using displacement residual. Subsequently, internal/external wave solver resources may be used to determine mapping between a wavelet magnitude and a scattering coefficient for mapping a general surface roughness to a general scattering magnitude.

Additionally, during a simulation, an adaptive tessellation of a base mesh may be implemented to adjust a geometry accuracy based on factors such as a distance/orientation of objects or regions, available power/computation budget, and/or regions of interest.

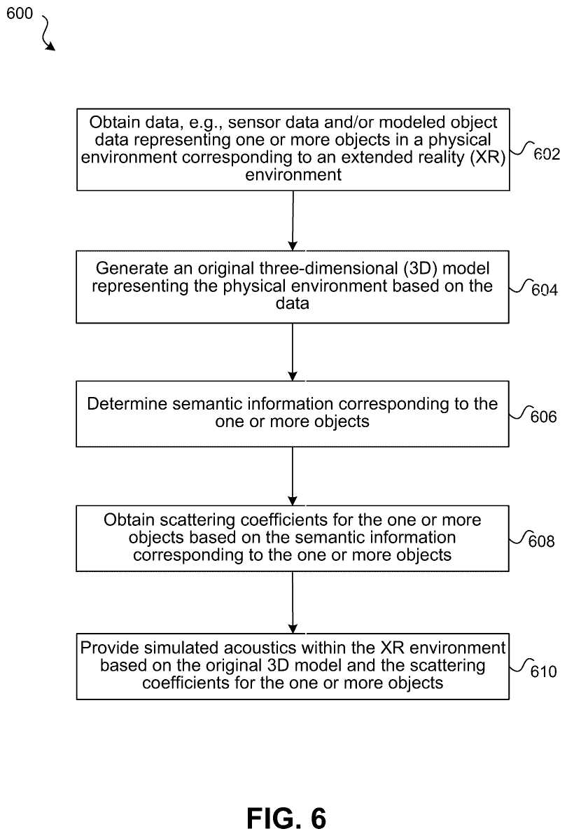

FIG. 6 is a flowchart representation of an exemplary method 600 that provides an acoustic simulation with respect to an object(s) in an XR space and/or any portion of an XR space using a 3D geometry of the object(s) and/or XR space and scattering coefficients associated with surfaces of the object(s) and/or the XR space, in accordance with some implementations. In some implementations, the method 600 is performed by a device(s), such as a tablet device, mobile device, desktop, laptop, HMD, server device, information system, etc. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains data, e.g., sensor data and/or modeled object data representing one or more objects in a physical environment corresponding to an extended reality (XR) environment. For example, sensor data may include image and depth data representing walls 120 and objects in (e.g., desk 110, television/monitor 115, plant 112, etc.) a physical environment 100 as described with respect to FIG. 1. Likewise, modeled object data may include data modeled using a 3D graphics application to create a high complexity mesh for visualization as described with respect to FIG. 1.

At block 604, the method 600 generates an original three-dimensional (3D) model representing the physical environment based on the data. In some implementations, the original 3D model may be a 3D mesh. For example, a 3D mesh representing a physical environment 100 may be generated as described with respect to FIG. 1.

At block 606, the method 600 determines semantic information corresponding to the one or more objects. In some implementations, the semantic information may include, inter alia, an object type of the one or more objects. For example, the semantic information may include, inter alia, a TV, a sofa, a wall, 3D shape dimensions determined via a bounding box(s), a scene type such as a living room, a bathroom, etc., object materials, etc. as described with respect to FIGS. 1 and 3.

At block 608, the method 600 obtains scattering coefficients for the one or more objects based on the semantic information corresponding to the one or more objects. For example, scattering coefficients of objects such as to walls 314a and 314b and objects 303, 305, 309, and 311 may be obtained as described with respect to FIG. 3.

In some implementations, obtaining scattering coefficients may include interpolating values with respect to dimensions of, for example, an object(s) or space. Likewise, scattering coefficients may be obtained using simplified compute models. In some implementations, obtaining the scattering coefficients may include identifying mean scattering coefficients for objects similar to each of the one or more objects. In some implementations, obtaining the scattering coefficients may include identifying the scattering coefficients stored in a database based on the semantic information. In some implementations, the scattering coefficients stored in the database are determined based on simulations of annotated geometrical acoustical (GT) data such as ground truth meshes including annotations, ground truth impulse response measurements, etc. as described with respect to FIG. 3.

In some implementations, the scattering coefficients stored in the database are determined using a simplified mesh with coefficients determined based on displacement information. For example, a simplified mesh of scanned objects 303, 305, 309, and 311 as described with respect to FIG. 3. In some implementations, object-specific scattering coefficients are computed for the one or more objects by: generating a simplified 3D model based on the original 3D model; determining portions of the simplified 3D model corresponding to portions of the original 3D model; generating displacement information (e.g., a displacement map such as displacement map 418 as described with respect to FIG. 4) for the portions of the simplified 3D model based on displacements (e.g., depth variability) for the portions (e.g., surfaces) of the original 3D model; and determining the object-specific scattering coefficients for the one or more objects based on the displacement information.

In some implementations, at least one of the scattering coefficients obtained using the semantic information is based on the object-specific scattering coefficients.

In some implementations, computing then object-specific scattering coefficients for the one or more objects is performed on a second electronic device different than the electronic device (e.g., information system 104 as described with respect to FIG. 1). In some implementations, computing object-specific scattering coefficients for the one or more objects comprises offloading computation to one or more edge nodes (e.g., local, cloud) based on determining that the electronic device is not connected to a power supply as described with respect to FIG. 5.

In some implementations, the original 3D model or scattering coefficients may be redetermined based on detecting a change in the XR environment exceeding a threshold.

At block 610, the method 600 provides simulated acoustics within the XR environment based on the original 3D model and the scattering coefficients for the one or more objects. In some implementations, providing simulated acoustics may include determining acoustic wave reflection or scattering from the one or more objects based on the scattering coefficients as described with respect to FIG. 1. The simulated acoustics within the XR environment may be provided, e.g., to a software application for a presentation to a user for accurate audio system design. Alternatively, the simulated acoustics within the XR environment may be provided, e.g., to an audio driver (e.g., of a computing device) for outputting accurate spatial audio.

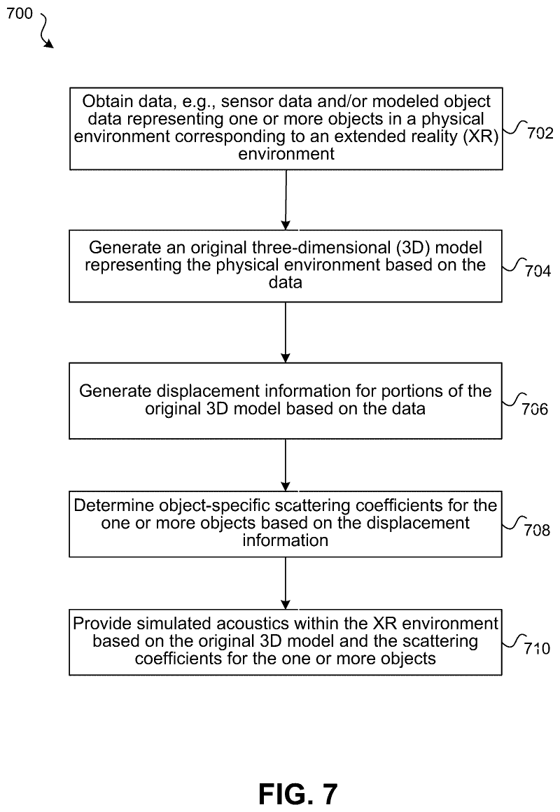

FIG. 7 is a flowchart representation of an exemplary method 700 that provides acoustic simulation with respect to an object(s) in an XR space and/or any portion of an XR space using a 3D geometry of the object(s) and/or XR space and scattering coefficients associated with surfaces of the object(s) and/or the in the XR space using mesh simplification and displacement mapping to determine scattering coefficients, in accordance with some implementations. In some implementations, the method 700 is performed by a device(s), such as a tablet device, mobile device, desktop, laptop, HMD, server device, information system, etc. In some implementations, the device has a screen for displaying images and/or a screen for viewing stereoscopic images such as a head-mounted display (HMD such as e.g., device 105 of FIG. 1). In some implementations, the method 700 is performed by processing logic, including hardware, firmware, software, or a combination thereof. In some implementations, the method 700 is performed by a processor executing code stored in a non-transitory computer-readable medium (e.g., a memory). Each of the blocks in the method 700 may be enabled and executed in any order.

At block 702, the method 700 obtains data such as, e.g., sensor data and/or modeled object data representing one or more objects in a physical environment corresponding to an extended reality (XR) environment. For example, sensor data may include image and depth data representing walls 120 and objects in (e.g., desk 110, television/monitor 115, plant 112, etc.) a physical environment 100 as described with respect to FIG. 1. Likewise, modeled object data may include modeled data using a 3D graphics application to create a high complexity mesh for visualization as described with respect to FIG. 1.

At block 704, the method 700 generates an original 3D model representing the physical environment based on the sensor data. In some implementations, the original 3D model may be a 3D mesh. For example, a 3D mesh representing a physical environment 100 may be generated as described with respect to FIG. 1.

At block 706, the method 700 generates displacement information (e.g., depth variability) for portions (e.g., surfaces) of the original 3D model based on the data. In some implementations, the displacement information is a displacement map. For example, displacement information such as displacement map 418 may be generated as described with respect to FIG. 4.

In some implementations, a surface roughness at a plurality of different scales is estimated by applying a 2D wavelet transform to the displacement map. Estimating the surface roughness may include generating a roughness map. In some implementations, a neural network may be configured to map wavelet coefficients to the scattering coefficients. For example, a surface roughness may be estimated at different scales using a 2D wavelet transform 502 applied to a mapping function 510 as described with respect to FIG. 5.

In some implementations, s-curve descriptors may be estimated based on the roughness map as implemented via process 500 as described in FIG. 5. In some implementations, a neural network may be configured to map wavelet coefficients to s-curve descriptors.

At block 708, the method 700 determines object-specific scattering coefficients for the one or more objects based on the displacement information as described with respect to FIG. 1.

At block 710, the method 700 provides simulated acoustics within the XR environment based on the scattering coefficients for the one or more objects. In some implementations, providing the simulated acoustics includes adaptively tessellating the original 3D model to adjust geometry accuracy based on: a distance or orientation of the one or more objects with respect to a viewpoint; an available power; a computational budget; and/or one or more regions of interest. For example, an adaptive tessellation of a base mesh as described with respect to FIG. 5. The simulated acoustics within the XR environment may be provided, e.g., to a software application for a presentation to a user for accurate audio system design. Alternatively, the simulated acoustics within the XR environment may be provided, e.g., to an audio driver (e.g., of a computing device) for outputting accurate spatial audio.

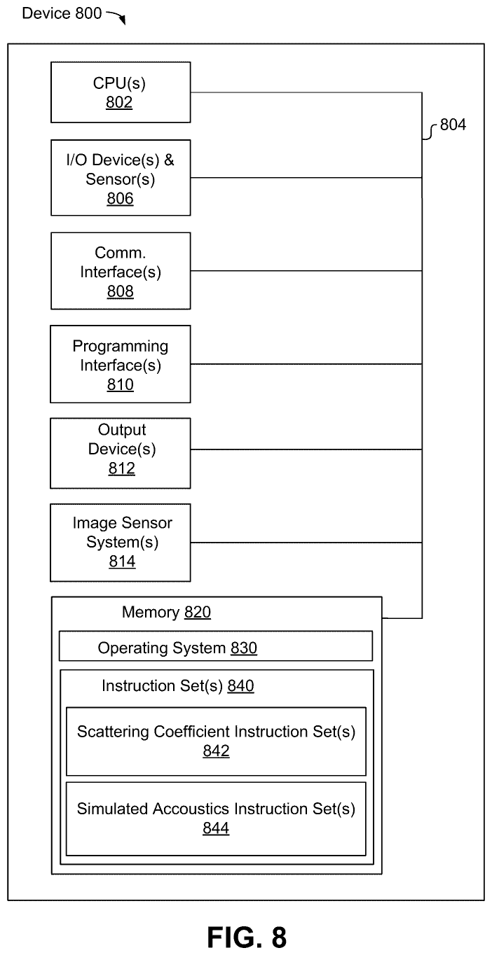

FIG. 8 is a block diagram of an example device 800. Device 800 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 810, output devices (e.g., one or more displays) 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 812 are configured to present a view of a physical environment, a graphical environment, an extended reality environment, etc. to the user. In some implementations, the one or more displays 812 are configured to present content (determined based on a determined user/object location of the user within the physical environment) to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the device 800 includes a single display. In another example, the device 800 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 800 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 800 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 800.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 includes a fragment layering instruction set 842 and a blending instruction set 844. The instruction set(s) 840 may be embodied as a single software executable or multiple software executables.

The fragment layering instruction set 842 is configured with instructions executable by a processor to identify a first group of fragments (e.g., only HL) for a first layer and a second group of the fragments (e.g., first WL and all fragments behind it for the pixel) for a second layer (for reprojection) based on the depths and fragment types of the fragments.

The blending instruction set 844 is configured with instructions executable by a processor to alpha blending a reprojected WL layer with an HL layer to generate an updated view of an XR environment.

Although the instruction set(s) 840 are shown as residing on a single device, it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a processor of an electronic device:
obtaining data representing one or more objects in a physical environment corresponding to an extended reality (XR) environment;
generating an original three-dimensional (3D) model representing the physical environment based on the sensor data or modeled object data;
determining semantic information corresponding to the one or more objects;
obtaining scattering coefficients for the one or more objects based on the semantic information corresponding to the one or more objects; and
providing simulated acoustics within the XR environment based on the original 3D model and the scattering coefficients for the one or more objects.

2. The method of claim 1, wherein obtaining the scattering coefficients comprises identifying mean scattering coefficients for objects corresponding to each of the one or more objects.

3. The method of claim 1, wherein obtaining the scattering coefficients comprises identifying the scattering coefficients stored in a database based on the semantic information.

4. The method of claim 3, wherein the scattering coefficients stored in the database are determined based on simulations of annotated geometrical acoustical (GT) data.

5. The method of claim 3, wherein the scattering coefficients stored in the database are determined using a simplified mesh with coefficients determined based on displacement information.

6. The method of claim 1, wherein said obtaining the scattering coefficients comprises interpolating values with respect to dimensions of each of the one or more objects.

7. The method of claim 1, wherein the semantic information comprises object types of the one or more objects.

8. The method of claim 1, wherein the semantic information comprises 3D shape dimensions of the one or more objects.

9. The method of claim 1, wherein the semantic information comprises materials of the one or more objects.

10. The method of claim 1, wherein the original 3D model is a 3D mesh.

11. The method of claim 1, wherein said providing simulated acoustics comprises determining acoustic wave reflection or scattering from the one or more objects based on the scattering coefficients.

12. The method of claim 1 further comprising computing object-specific scattering coefficients for the one or more objects by:
generating a simplified 3D model based on the original 3D model;
determining portions of the simplified 3D model corresponding to portions of the original 3D model;
generating displacement information for the portions of the simplified 3D model based on displacements for the portions of the original 3D model; and
determining the object-specific scattering coefficients for the one or more objects based on the displacement information.

13. The method of claim 12 further comprising:
updating at least one of the scattering coefficients obtained using the semantic information, the at least one of the scattering coefficients updated based on the object-specific scattering coefficients.

14. The method of claim 12, wherein computing the object-specific scattering coefficients for the one or more objects is performed on a second electronic device different than the electronic device.

15. The method of claim 14, wherein computing the object-specific scattering coefficients for the one or more objects comprises offloading computation to one or more edge nodes based on determining that the electronic device is not connected to a power supply.

16. The method of claim 1 further comprising determining to redetermine the original 3D model or scattering coefficients based on detecting a change in the XR environment exceeding a threshold.

17. The method of claim 1, wherein the data comprises sensor data or modeled object data.

18. A system comprising:
a processor;
a computer readable medium storing instructions that when executed by the processor cause the processor to perform operations comprising:
obtaining data representing one or more objects in a physical environment corresponding to an extended reality (XR) environment;
generating an original three-dimensional (3D) model representing the physical environment based on the sensor data or modeled object data;
determining semantic information corresponding to the one or more objects;
obtaining scattering coefficients for the one or more objects based on the semantic information corresponding to the one or more objects; and
providing simulated acoustics within the XR environment based on the original 3D model and the scattering coefficients for the one or more objects.

19. The system of claim 18, wherein obtaining the scattering coefficients comprises identifying mean scattering coefficients for objects corresponding to each of the one or more objects.

20. A non-transitory computer-readable medium comprising instructions that when executed by a processor cause the processor to perform operations comprising:
obtaining data representing one or more objects in a physical environment corresponding to an extended reality (XR) environment;
generating an original three-dimensional (3D) model representing the physical environment based on the sensor data or modeled object data;
determining semantic information corresponding to the one or more objects;
obtaining scattering coefficients for the one or more objects based on the semantic information corresponding to the one or more objects; and
providing simulated acoustics within the XR environment based on the original 3D model and the scattering coefficients for the one or more objects.
